(19) United States
(12) Patent Application Publication
(10) Pub. No.: US 2014/0302909 A1
(43) Pub. Date: Oct. 9, 2014

(54) ELECTRONIC GAMING MACHINE AND GAMING METHOD

(71) Applicant: AINSWORTH GAME TECHNOLOGY LIMITED, Newington (AU)

(72) Inventor: Jason Meyer, Abbotsford (AU)

(21) Appl. No.: 14/305,278

(22) Filed: Jun. 16, 2014

(30) Foreign Application Priority Data
Jun. 17, 2013 (AU) 2013902179
May 23, 2014 (AU) 2014901948

(51) Int. Cl. G07F 17/34

(52) U.S. Cl. CPC G07F 17/34
USPC 463/20

(57) ABSTRACT

An electronic gaming machine includes a display for displaying a game and a wheel-type game. The wheel-type game comprises a plurality of wheels, said wheels having different wheel elements. An electronic game controller controls the display of game symbols and wheel elements in said game and said wheel-type game. The electronic game controller configures the electronic gaming machine to provide a plurality of selectable bet options to play said game. The electronic game controller also associates each of said bet options with one of said wheels such that selection of a first bet option to play said game causes said electronic game controller to select the wheel associated with said first bet option.

### BACKGROUND

The present invention relates to an electronic gaming machine and in a particular an electronic gaming machine having a game and a wheel-type game. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, computational processor or other central processing unit, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

One type of electronic gaming machine offers multiple sets of reels to permit a player to play several reels at the same time, depending on the amount that is wagered or bet by the player. For example, a gaming machine could offer four reel sets each having 50 pay lines available for selection by the player. By wagering a suitable amount, such as 200 credits, the player can play all 50 pay lines and thus all four reel sets.

Another type of gaming machine employs are “wheel”-type game concept where a circular-shaped wheel is divided into segments that award a variety of prizes, such as bonus prizes, multipliers, progressive prizes and even free games, as well as non-winning outcomes, such as “bankruptcy” or “lose”. In operation, the wheel spins and the pointer or flipper indicates which segment is won by the player and the associated prize or non-winning outcome. This wheel concept has been extended to mechanical and electronic gaming machines that use multiple wheels in many different formats.

Bonus or “feature” games may also be provided by an electronic gaming machine in addition to a base or main game. Typically feature games use the same set of reels as the main game and are limited to a set of free games operated under a single set of rules. This means that the feature game is restricted by the same set of rules, and so there is no variation in the play of the feature game. Consequently, it is difficult to retain player interest because there is no apparent incentive for the player to continue playing the same electronic gaming machine once the player becomes familiar with the feature game and the main game. Also, it is difficult to retain player interest since there is little differentiation between gaming machines in terms of the main and feature games that are played.

It is an object of the present invention to overcome or substantially ameliorate one or more of the disadvantages of prior art, or at least to provide a useful alternative.

It is an object of the invention in at least one preferred form to provide an electronic gaming machine and a gaming method for an electronic gaming machine that encourages player interest.

### SUMMARY

According to a first aspect of the invention, there is provided an electronic gaming machine comprising:

a display for displaying a game and a wheel-type game, wherein predetermined winning combinations of randomly selected game symbols in said game award prizes to a player and randomly selected wheel elements in said wheel-type game award prizes and/or confer game enhancing elements to said player, said wheel-type game comprising a plurality of wheels, said wheels having different wheel elements to vary the probability of winning a prize or game enhancing element in said wheel-type game, and

an electronic game controller for controlling the display of said game symbols and said wheel elements in said game and said wheel-type game, respectively, on said display,

wherein said electronic game controller configures said electronic gaming machine to provide a plurality of selectable bet options to play said game and said electronic game controller associates each of said bet options with one of said wheels such that selection of a first bet option to play said game causes said electronic game controller to select the wheel associated with said first bet option.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Also, throughout the description and the claims, the term “wheel” refers to an array of predetermined game positions where the game positions are visually rotatable about an axis of the array. Similarly, throughout the description and the claims, the term “wheel-type game” refers to a game where the wheel is partially visible or fully visible on the display, and is visually rotated or “spun” and when the wheel stops rotating, one of the predetermined game positions is selected (typically randomly) to award a prize or other game enhancing element to a player. Thus, it will be appreciated from the above definition that a wheel-type game is not limited to circular wheels, but may include wheels having other shapes, such as but not limited to triangular, rectangular, square, hexagonal, pentagonal, octagonal and other polygonal shapes.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Preferably, the probability of winning a prize or game enhancing element in said wheel-type game in each wheel is proportional to the amount of said first bet option.

Preferably, at least one of said prizes in each wheel comprises a jackpot prize and each said wheel comprises one or more jackpot wheel elements which awards said jackpot prize to said player. More preferably, said first bet option comprises a number of credits and the number of said jackpot wheel elements is proportional to the number of said credits. Alternatively, said first bet option comprises a number of credits and the number of said jackpot wheel elements is equal to the number of said credits.

In a further preferred form, said game comprises an array of predetermined game positions which are occupied by said randomly selected game symbols and said predetermined winning combinations are defined by a plurality of selectable combinations of said game positions, said first bet option comprises a number C of credits bet per selectable combination and said wheel associated with said first bet option comprises a number J of said jackpot wheel elements, and wherein the other of said bet options each comprise n×C credits bet per selectable combination where n×C is proportional to C, and the wheels respectively associated with each of said other bet options comprise n×J jackpot wheel elements. In an alternative preferred form, said first bet option comprises a total number of C credits bet in a play of said game and said wheel associated with said first bet option comprises a number J of said jackpot wheel elements, and wherein the other of said bet options each comprise n×C credits bet in said play of said game where n×C is proportional to C and the wheels respectively associated with each of said other bet options comprise n×J jackpot wheel elements. In yet another preferred form, said game comprises an array of predetermined game positions which are occupied by said randomly selected game symbols, said predetermined winning combinations are defined by a plurality of combinations of said game positions and said game position combinations are formed into two or more selectable groups of combinations, said first bet option comprises a number C of credits bet per selectable group and said wheel associated with said first bet option comprises a number J of said jackpot wheel elements, and wherein the other said bet options each comprise n×C credits bet per selectable group where n is proportional to C, and the wheels respectively associated with each of said other bet options comprise n×J jackpot wheel elements. The number n is preferably a positive integer (1, 2, 3, etc.) but can be a fraction such as ½, ¾, 3/2, etc.

Preferably, said electronic game controller changes said selected wheel in response to a change from said first bet option to a second bet option different to said first bet option, said electronic game controller selecting the wheel associated with said second bet option. More preferably, said electronic game controller causes the wheel associated with said second bet option to be at least partly displayed on said display to indicate the change in said selected wheel to said player.

Preferably, at least one of said wheels comprises a wheel element that confers a first bonus prize, said first bonus prize comprising a fixed amount multiplied by the amount of said first bet option or said second bet option.

Preferably, at least one of said wheels comprises a wheel element that confers a second bonus prize comprising a randomly chosen value.

Preferably, the number of said wheel elements in each of said wheels is the same, and at least one of said wheel elements in at least two of said wheels awards the same prize or game enhancing element. Alternatively or additionally, wherein the number of said wheel elements in each of said wheels is the same, and at least one wheel element in one of said wheels awards a different prize or game enhancing element to the prize or game enhancing element awarded by at least one wheel element in another of said wheels.

Preferably, a trigger combination of game symbols appearing in said game triggers said selected wheel to randomly select one of its wheel elements. More preferably, said trigger combination comprises five of the same game symbols appearing in said game.

Preferably, said game comprises a base game and/or a feature game. More preferably, said game comprises a base game and a feature game, wherein a feature game trigger event occurs in said base game to trigger said feature game and said selected wheel is activated during said feature game. In one preferred form, said feature game trigger event comprises a random event determined by said electronic game controller at the start of play of said feature game. In another preferred form, the feature game trigger event comprises the appearance of at least one trigger symbol in said first arrays. In another alternative, the feature game trigger event comprises an in-game event during play of the games on said first array.

Preferably, said one or more game enhancing elements modify the result of a play of said game.

Preferably, said selected wheel randomly awards said one or more prizes and/or game enhancing elements once a first play of the game is completed. More preferably, said selected wheel individually selects said prizes and/or game enhancing elements for awarding to said player. Where more than one prize and/or game enhancing element is awarded by said selected wheel, said selected wheel sequentially selects said prizes and/or game enhancing elements for awarding to said player.

Preferably, said wheels do not include game enhancing elements that modify the function of said game symbols. More preferably, said game enhancing elements are arranged in said wheels without defining any pay lines or predetermined combination of wheel elements. In one preferred form, said game comprises pay lines or predetermined combinations of predetermined game positions for determining said predetermined winning combinations. In another preferred form, said wheels do not have any game enhancing elements that is a substitute for pay lines, including “ways”, “anys” or “scatters”.

Preferably, the game enhancing elements comprise at least one or more of a predetermined number of free games, an enhanced wheel, bonus prizes, collector symbols, a win multiplier, wild multipliers, bonus wilds, symbols that cause the award of additional free games, trigger symbols to retrigger the selected wheel or enhanced wheel, directly retriggering the selected wheel or enhanced wheel, held columns, random wild symbols, progressives, bonus credits, jackpot symbols, and one or more symbol replacements.

Preferably, said enhanced wheel modifies a feature game. More preferably, said enhanced wheel randomly awards one or more game enhancing elements that modify the result of each play of said feature game.

Preferably, the award of free games also triggers replacement of said selected wheel with the enhanced wheel, said enhanced wheel offering more types of game enhancing elements than said selected wheel. In one preferred form, said enhanced wheel modifies the free games played. More preferably, said selected wheel randomly awards one or more game enhancing elements that modify the result of each said free game.

Preferably, said wheels and said enhanced wheels take any one of a circular, triangular, oval, semi-circular, hexagonal, pentagonal, octagonal, non-rectangular or polygonal shape. In one preferred form, said wheels and said enhanced wheels arrays take the form of partially shown circular wheels.

Preferably, said electronic game controller causes the display of said game with said selected wheel during play of said game. In one preferred form, the selection of said selected wheel is indicated on said display.

Preferably, the player selectively starts and/or stops play of said selected wheel and/or said enhanced wheel.

Preferably, the electronic gaming machine comprises a mobile electronic gaming device. More preferably, said mobile electronic gaming device comprises a handheld electronic device. In one preferred form, said handheld electronic device comprises a handheld electronic gaming device or a smart phone. Alternatively, said electronic gaming machine comprises a computer. More preferably, said computer is connected to a communication network.

According to a second aspect of the invention, there is provided a gaming method for an electronic gaming machine comprising a display and an electronic game controller, comprising:

controllably displaying a game and a wheel-type game, wherein predetermined winning combinations of randomly selected game symbols in said game award prizes to a player and randomly selected wheel elements in said wheel-type game award prizes and/or confer game enhancing elements to said player;

providing a plurality of wheels for said wheel-type game, said wheels having different wheel elements to vary the probability of winning a prize or game enhancing element in said wheel-type game;

providing a plurality of bet options to play said game;

associating each of said bet options with one of said wheels;

receiving a selection of a first bet option to play said game, and

selecting the wheel associated with said first bet option for play with said game.

Preferably, said associating step further comprises associating a wheel with said first bet option so that the probability of winning a prize or game enhancing element in said selected wheel is proportional to the amount of said first bet option.

Preferably, said method further comprises providing a jackpot prize as at least one of said prizes awarded by each wheel and providing each said wheel with one or more jackpot wheel elements which awards said jackpot prize to said player.

Preferably, said method further comprises receiving a second bet option different to said first bet option and changing said selected wheel to the wheel associated with said second bet option. More preferably, said method further comprises indicating said change in said selected wheel to said player. In one preferred form, said method further comprises displaying at least part of said wheel associated with said second bet option to indicate said change.

Preferably, said method further comprises providing at least one of said wheels with a wheel element that confers a first bonus prize, said first bonus prize comprising a fixed amount multiplied by the amount of said first bet option or said second bet option.

Preferably, said method further comprises providing at least one of said wheels with a wheel element that confers a second bonus prize comprising a randomly chosen value.

Preferably, said method further comprises providing the same number of said wheel elements in each of said wheels is the same, and providing at least one of said wheel elements in at least two of said wheels to award the same prize or game enhancing element. Alternatively or additionally, said method further comprises providing the same number of said wheel elements in each of said wheels is the same, and providing at least one wheel element to award a different prize or game enhancing element to the prize or game enhancing element awarded by at least one wheel element in another of said wheels.

Preferably, said method further comprises triggering said selected wheel to randomly select one of its wheel elements, said triggering being in response to a trigger combination of game symbols appearing in said game. More preferably, said trigger combination comprises five of the same game symbols appearing in said game.

Preferably, said method further comprises said selected wheel randomly awarding said prize and/or game enhancing element once said game is completed.

The method also preferably has the preferred features of the first aspect of the invention stated above, where applicable.

According to a third aspect of the invention, there is provided a gaming system comprising a central processing unit configured for communication with an electronic gaming machine, wherein said gaming system is configured to perform the method of the second aspect of the invention on said electronic gaming machine.

According to a fourth aspect of the invention, there is provided a computer programme configured to perform the method of the second aspect of the invention.

According to a fifth aspect of the invention, there is provided a non-transitory carrier medium carrying computer executable code that, when executed on a central processing unit configured for communication with an electronic gaming machine, causes the central processing unit to perform the method of the second aspect of the invention on said electronic gaming machine.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to a first embodiment of the invention;

FIG. 2 is a schematic drawing of an electronic game controller for the electronic gaming machine of FIG. 1;

FIGS. 3 to 5 are front views of the display of the electronic gaming machine of FIG. 1 illustrating a first wheel-type game;

FIGS. 6 and 7 are front views of the display of the electronic gaming machine of FIG. 1 illustrating a second wheel-type game;

FIGS. 8 and 9 are front views of the display of the electronic gaming machine of FIG. 1 illustrating a third wheel-type game;

FIGS. 10 and 11 are front views of the display of the electronic gaming machine of FIG. 1 illustrating a fourth wheel-type game;

FIGS. 12 and 13 are front views of the display of the electronic gaming machine of FIG. 1 illustrating a fifth wheel-type game,

FIG. 14 is a front view of the display of the electronic gaming machine of FIG. 1 illustrating the wheel-type game of FIGS. 8 and 9 in a feature game;

FIG. 15 is a front view of a display illustrating a first wheel-type game for an electronic gaming machine according to a second embodiment of the invention;

FIG. 16 is a front view of a display illustrating a second wheel-type game for an electronic gaming machine according to the second embodiment of the invention;

FIG. 17 is a front view of a display illustrating a third wheel-type game for an electronic gaming machine according to the second embodiment of the invention;

FIG. 18 is a front view of a display illustrating a fourth wheel-type game for an electronic gaming machine according to the second embodiment of the invention;

FIG. 19 is a front view of a display illustrating a fifth wheel-type game for an electronic gaming machine according to the second embodiment of the invention; and

FIG. 20 is a front view of a display illustrating a sixth wheel-type game for an electronic gaming machine according to the second embodiment of the invention.

### DETAILED DESCRIPTION OF THE VARIOUS EMBODIMENTS

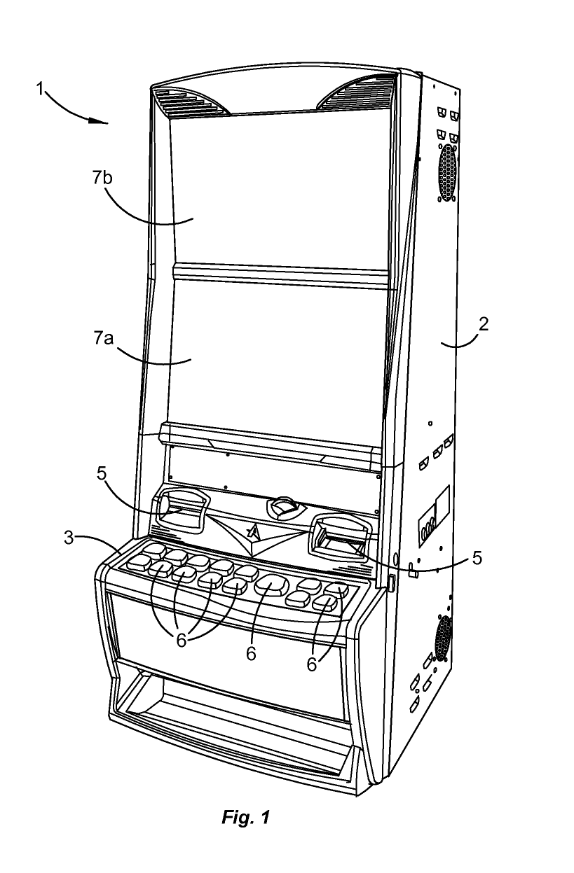

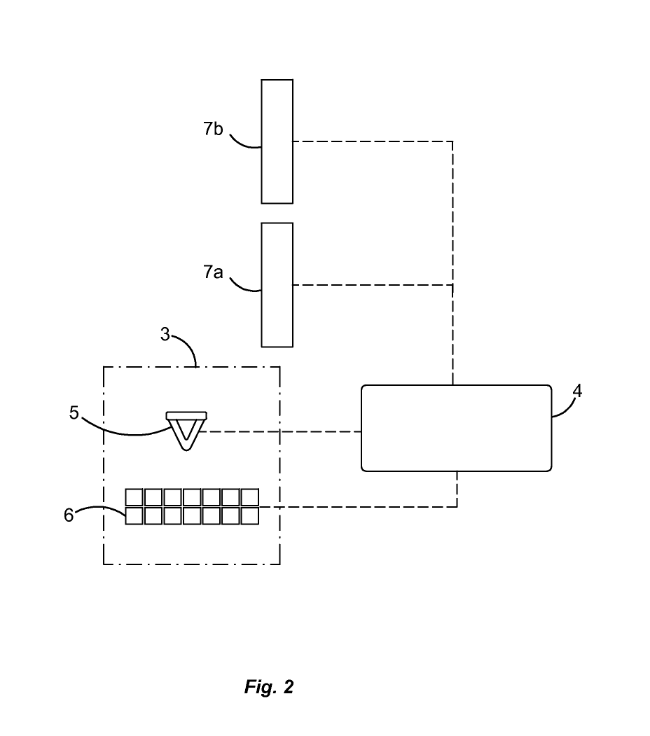

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. The electronic game controller 4 is generally in the form of a central processing unit, such as a computer, and is in electronic communication with a display 7 in the form of two video display screens 7a and 7b, as well as various input devices on the console 3. It is also appreciated that a person skilled in the art would readily understand the location and use of the electronic game controller 4 in the electronic gaming machine 1.

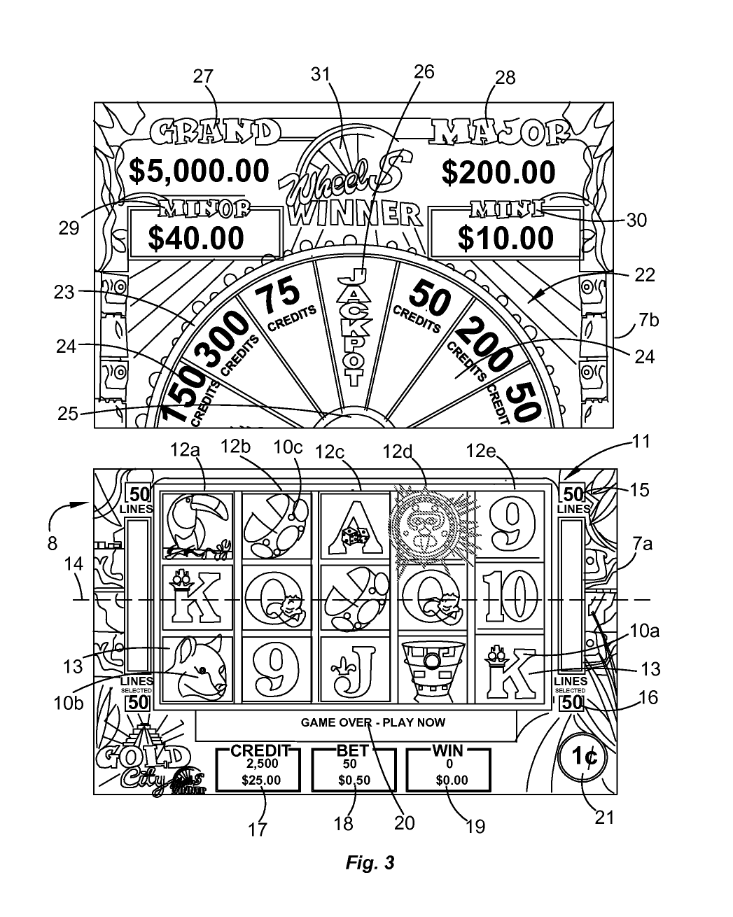

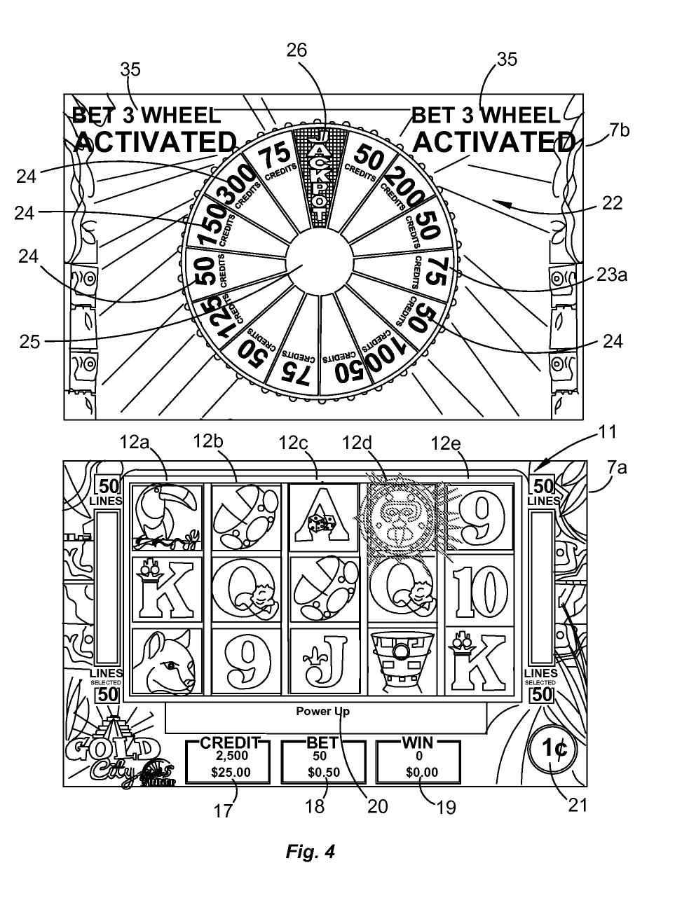

The electronic game controller 4 is programmed to provide a game in the form of a base game 8 (as best shown in FIG. 3) and a feature game 9 (as best shown in FIGS. 4 to 7) on the electronic gaming machine 1 for play by a player. The base game 8 has game symbols 10 arranged into an array 11 in the form of five columns or “reels” 12, as best shown in FIG. 3. While the array 11 is arranged with five reels 12 and three rows, it will be appreciated by one skilled in the art that other types of arrays could be used, such as 3×3, 4×3, 5×5, 4×4, etc. including arrays having an irregular number of rows and/or columns.

The array 11 of the base game 8 defines predetermined positions in the form of “squares” or cells 13, in which the game symbols 10 appear. The array 11 is arranged so that a player can select one or more predetermined “pay lines” 14 defined around the array, which correspond to combinations of the positions or cells 13. The pay lines 14 correspond to the lines selected by the player and generally comprise at least one game position or cell 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player. In the feature game 9, predetermined winning combinations of randomly selected game symbols 10 also result in the award of prizes to the player, usually of an enhanced value compared to the prizes awarded in the base game 8.

The game symbols 10 can include a mixture of picture symbols (such as animal symbols or playing card symbols), word symbols, scatter symbols, substitute or wild card symbols and trigger symbols to trigger the feature game 9. In this embodiment, the game symbols 10 include playing card symbols 10a, animal-themed symbols 10b, item-themed symbols 10c, scatter symbols in the form of gold mask symbols 10d and a substitute or wild card symbol in the form of “Gold City” symbols 10e. The electronic game controller 4 randomly determines the appearance of the game symbols 10 on the array 11.

The lower video screen 7a also displays other standard game information including the number of pay lines available 15, the number of player-selected pay lines 16, the amount of player credits 17, the amount of the current bet wagered by the player 18, the amount of wins by the player 19, a message area 20 and a current denomination button 21 indicating the currently selected base bet denomination.

The upper video screen 7b displays a wheel-type game 22 that is linked to the base game 8 in the form of a wheel 23 that is only partly shown on-screen, as best shown in FIGS. 3 and 4. The wheel 23 has a plurality of wheel elements in the form of segments or wedges 24 that rotate about a central axis 25 of the wheel. The wedges 24 award prizes or game enhancing elements to the player, such as fixed amount of credits (50 credits, 75 credits, 150 credits, 200 credits, 300 credits, etc.) and a jackpot wheel element or wedge 26.

In the embodiment, there is a plurality of wheels 23 that are selectable by the electronic game controller 4, based on the amount of the bet made by the player to play the base game 8. Each of the wheels 23 share some of the same wedges, but also may have wedges unique to that wheel. Also, in this embodiment, the number of jackpot wedges 26 is directly proportional or related to the amount of the bet made by the player, as discussed in more detail below. The electronic game controller 4 also pays out any wins that have occurred on any player-selected pay lines 14 of the base or feature game 8, 9 played on the game array 11 in addition to the prizes and/or game enhancing elements awarded by the selected wheel 23.

The upper video screen 7b also displays jackpot information relating to the game 8 that is awarded via the wheel 23. This jackpot information comprises, in descending order of monetary value, a grand jackpot 27, major jackpot 28, minor jackpot 29 and midi jackpot 30. The name 31 of the game, “Wheel Winner”™, playable on the electronic gaming machine 1, is also displayed on the upper video screen 7b.

In contrast to the array 11 of the base game 8, the wheel 23 of the wheel-type game 22 arranges the wedges 24 in either a random or preset pattern without defining any pay lines or predetermined combination of cells. Thus, the wheel 23 does not award its prizes or game enhancing elements using combinations of game symbols 10. Also, the wheel 23 does not have any prize or game enhancing element that is a substitute for pay lines such as industry known winning patterns like “ways”, “anys” or “scatters”. As such, only the array 11 comprise pay lines 14 or predetermined combinations of game enhancing symbol positions for determining said predetermined winning combinations.

The entire wheel 23 may be shown on the display or only a portion of the wheel is shown. For example, in this embodiment half of the wheel 23 is shown but as the wheel rotates, the initially unseen portion of the wheel rotates into view on the upper video screen display 7b.

In another embodiment, the wheel 23 is shown end-wise as if the axis of rotation of the wheel were parallel to the plane of the display 7 so that the wheel rotates towards the player. This end orientation of the wheel 23 may further encourage player interest where a 3D-type display is used for the electronic gaming machine 1, as the wheel 23 would appear to rotate out of the display 7 towards the player.

The player initially makes a bet using vending slots 5 initiate play of the electronic gaming machine 1 to build up credit to play the base game 8 on the electronic gaming machine. For example, the player can bet or wager monetary amounts equivalent to a particular amount of credits, depending on the bet denomination selected for the base game. Also, the player can make any additional side bets or ante-bets during play of the base game once the game has commenced to access additional features in the game, such as increasing the number of winning combinations in the game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc.

The amount of the bet or bet option that the player makes to play the base game 8 determines which wheel 23 of the wheel-type game 22 is selected by the electronic game controller 4. In this embodiment, the number of credits bet per pay line 14 determines which of the wheels 23 are selected. Where the player makes a bet of 1 credit per pay line 14, the wheel 23a (called a “Bet 1” wheel in the game 22) is selected by the electronic game controller 4 and displayed on the upper video screen 7b during the base game 8. The selected wheel 23a is then fully displayed on the upper video screen 7b to indicate to the player which wheel 23 has been selected, as best shown in FIG. 4. The wedges 24 of the wheel 23a have a distinct purple colour to further identify the Bet 1 Wheel to the player. Also, in this embodiment, the Bet 1 wheel 23a has only one jackpot wedge 26, equal to the number of credits per line that has been bet by the player.

The electronic game controller 4 then causes the reels 12 to appear to visibly rotate or “spin”, and randomly display the game symbols 10 in each cell 13 for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind. It will be appreciated that other winning combinations of game symbols 9 can also be provided. If so, the gaming machine 1 enters a winning game state and awards a prize according to the displayed predetermined winning combination.

The electronic game controller 4 will also determine whether the selected wheel 23a should be activated, based on a trigger event in the base game 8. In this embodiment, the trigger event is a combination of five of the same game symbols 10; i.e. a five of a kind. This combination thus not only provides a winning combination of game symbols in the base game 8 but also acts as a “trigger” combination to activate the selected wheel 23a. The trigger combination can be a “pure” combination of the game symbols 10 or a mixture of the same game symbols 10 and substitute symbols in the form of the Gold City symbols 10e.

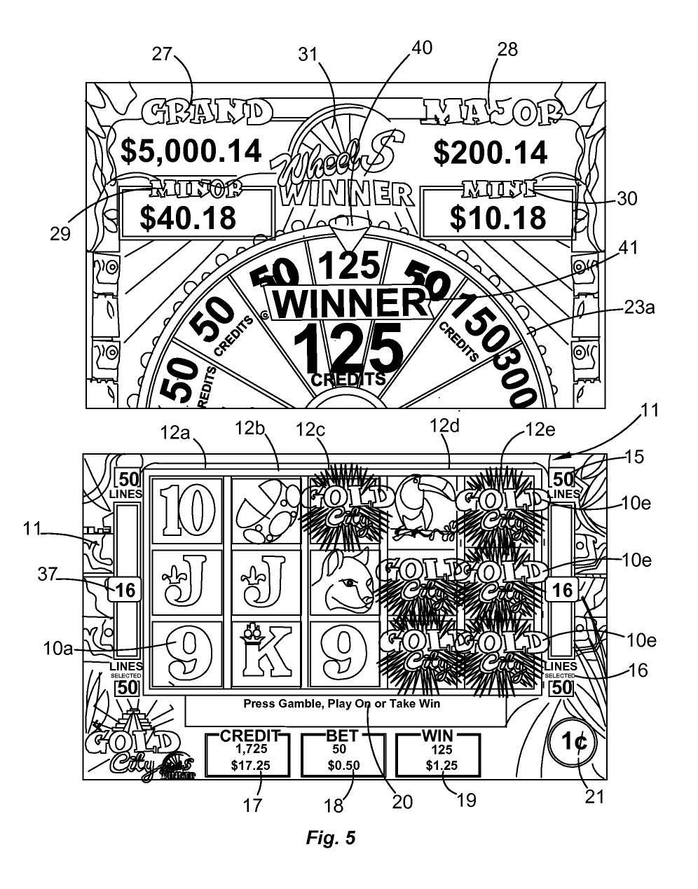

In response to the trigger event of a five of a kind in base game 8, the electronic game controller 4 indicates to the player that the selected Bet 1 wheel 23a has been activated by displaying the Bet 1 wheel 23a in full and a message 35 in the upper video screen 7b, as best shown in FIG. 4. The upper video screen 7b then returns to the display of half of the Bet 1 wheel 23a as in FIG. 3. The electronic game controller 4 then activates the wheel 23 to visually rotate or “spin” and randomly select one of the wedges 24 to award to the player. The random selection of one of the wedges is indicated by a pointer 40 that appears at the top of the selected wheel 23a and a congratulatory message 41 appears superimposed over the selected wheel advising the prize or game enhancing element awarded to the player, as best shown in FIG. 5. In this example, the trigger combination of five playing card “J” or Jack symbols 10a has appeared in the array 11 of base game 8, comprising two “J” playing card symbols and three substitute Gold City symbols 10e. This has activated the selected Bet 2 wheel 23b, which has randomly selected the award of 125 credits. An indicator 37 on the array 11 shows the number of playable pay lines 14 that have been selected by the player is also shown in FIG. 5.

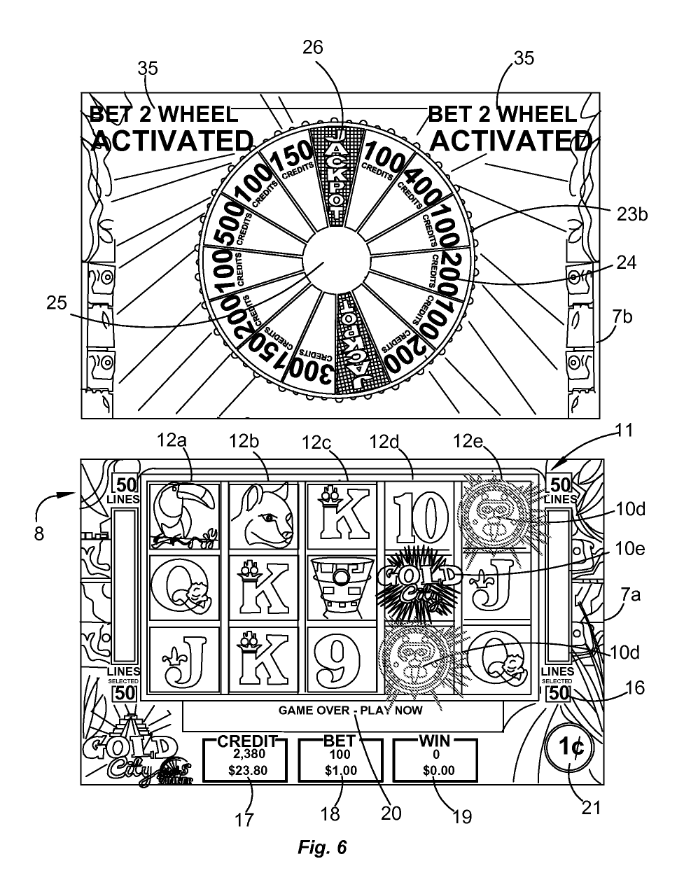

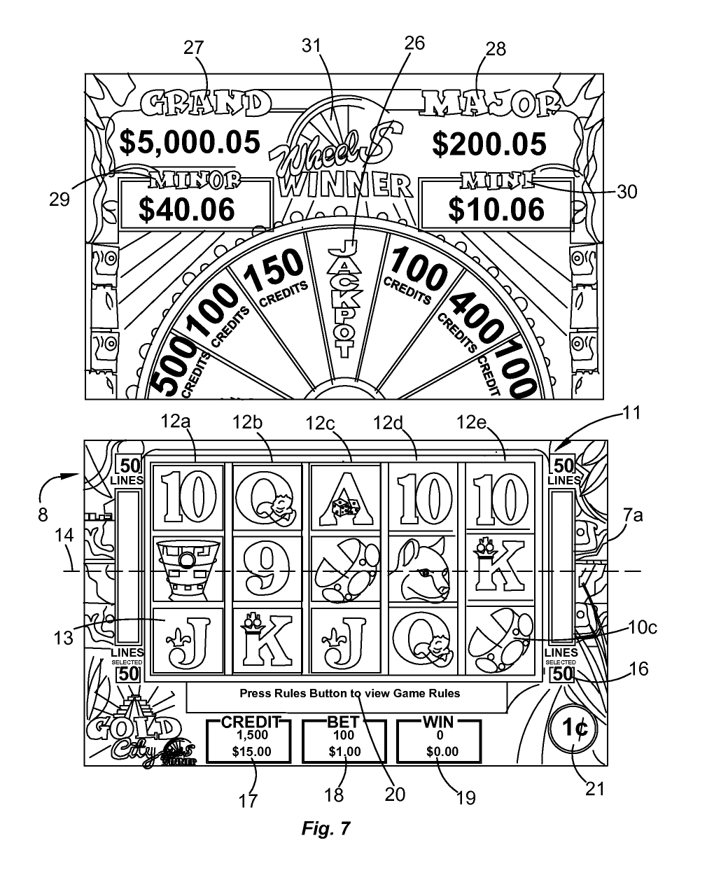

The electronic gaming machine 1 then returns to the base game 8, where the player can continue playing the base game 8 or decide to change his or her bet for the next play of the base game. If the bet is changed to a higher or lower amount, then the electronic game controller will select a new wheel 23 that corresponds to the changed amount of the bet. For example, if the player were to increase his or her bet to two credits per pay line 14, then the electronic game controller 4 changes the Bet 1 wheel 23a to a “Bet 2” wheel 23b, as best shown in FIGS. 6 and 7, where corresponding features have been given the same reference numeral. The Bet 2 wheel 23b has the same number of wedges 24 as the Bet 1 wheel 23a, but either provides prizes of increased value that were not available in the Bet 1 wheel (such as the wedges awarding 400 credits and 500 credits) or an increased probability of winning the same prize offered on the Bet 1 wheel (such as three wedges awarding 200 credits in the Bet 2 wheel, whereas there is only one wedge awarding 200 credits in the Bet 1 wheel). Also, the number of jackpot wedges 26 has increased so as to be equal to the number of credits bet per line, from one wedge in the Bet 1 wheel to two wedges in the Bet 2 wheel.

The change of the selected wheel 23 is indicated to the player on the upper video screen 7b, as best shown in FIG. 6, except that the “activated” part of the message 35 is omitted since the Bet 2 wheel has not been activated yet. In addition, the Bet 2 wheel 23b has blue coloured wedges 24 to further distinguish it from the Bet 1 wheel 23a. The electronic gaming machine 1 then continues with play of the base game 8 as described above and as shown in FIG. 7. It will be appreciated that not every play of the base game 8 will trigger activation of the selected wheel 23 and a player may change the bet and hence the selected wheel even if there has been no triggering or activation of the selected wheel.

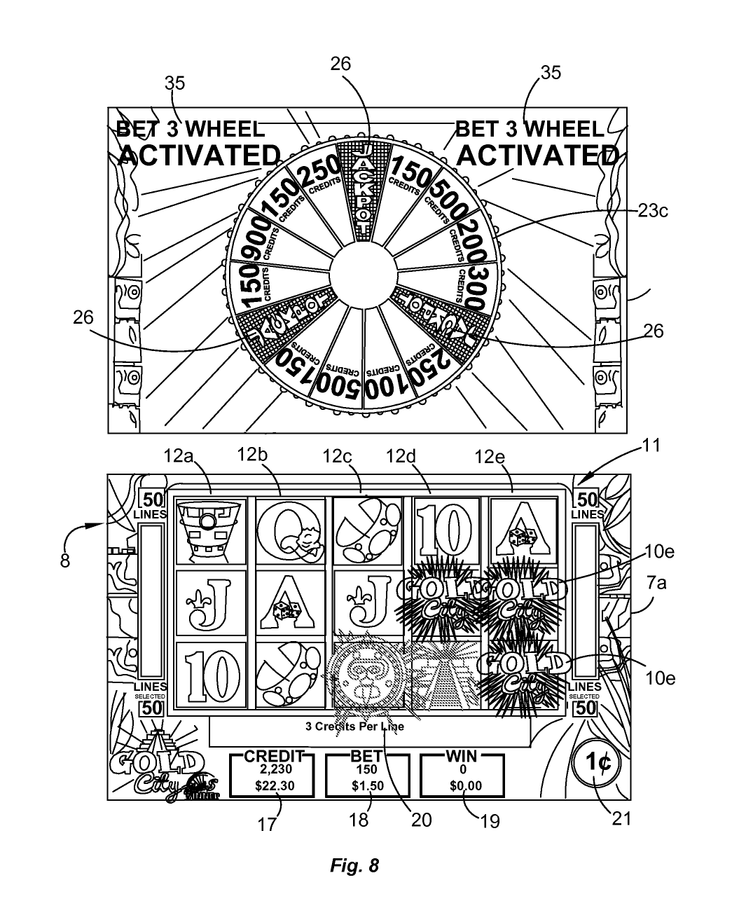

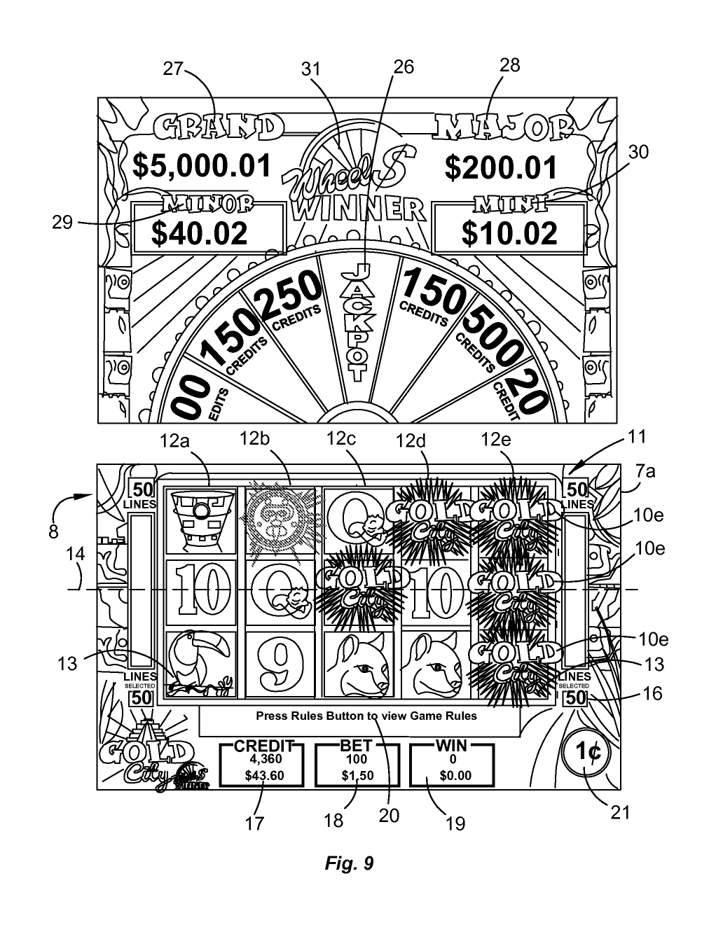

This operation of the electronic gaming machine 1 is repeated for each of the wheels 23 that can be used in the wheel-type game 22 based on the bet made by the player. A bet of three credits per pay line 14 results in selection of a “Bet 3” wheel 23c, as best shown in FIG. 8. The Bet 3 wheel 23c has three jackpot wedges 26, equal to the number of credits bet per pay line 14, thus providing an increase probability of winning a jackpot compared to the Bet 1 and Bet 2 wheels 23a, 23b. The other wedges 24 of the Bet 3 wheel 23c also provide increased chances of winning the same prize from the Bet 1 and Bet 2 wheels 23a, 23b (such as three wedges awards 150 credits instead of only two such wedges in the Bet 2 wheel) or a prize of higher value (such as the wedge awarding 900 credits). The Bet 3 wheel 23c also has dark red coloured wedges 24 to further distinguish itself from the purple Bet 1 wheel 23a and the blue Bet 2 wheel 23b. The message bar 20 also indicates to the player the number of credits that have been bet per pay line 14. Again, the upper video screen 7b changes to continue play of the base game 8 with the selected Bet 3 wheel 23c, as best shown in FIG. 9.

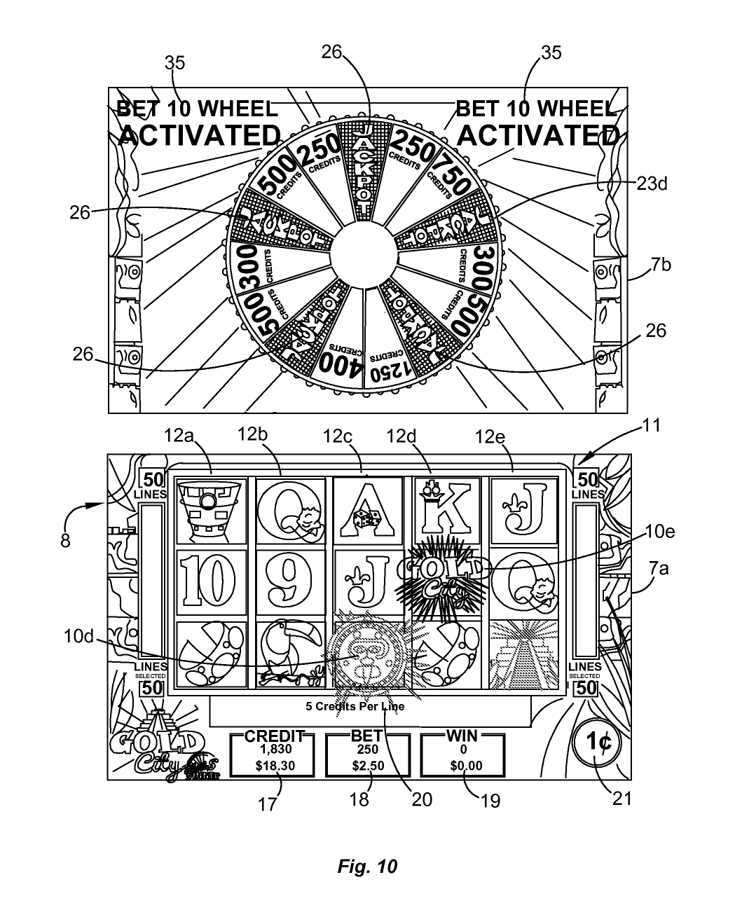

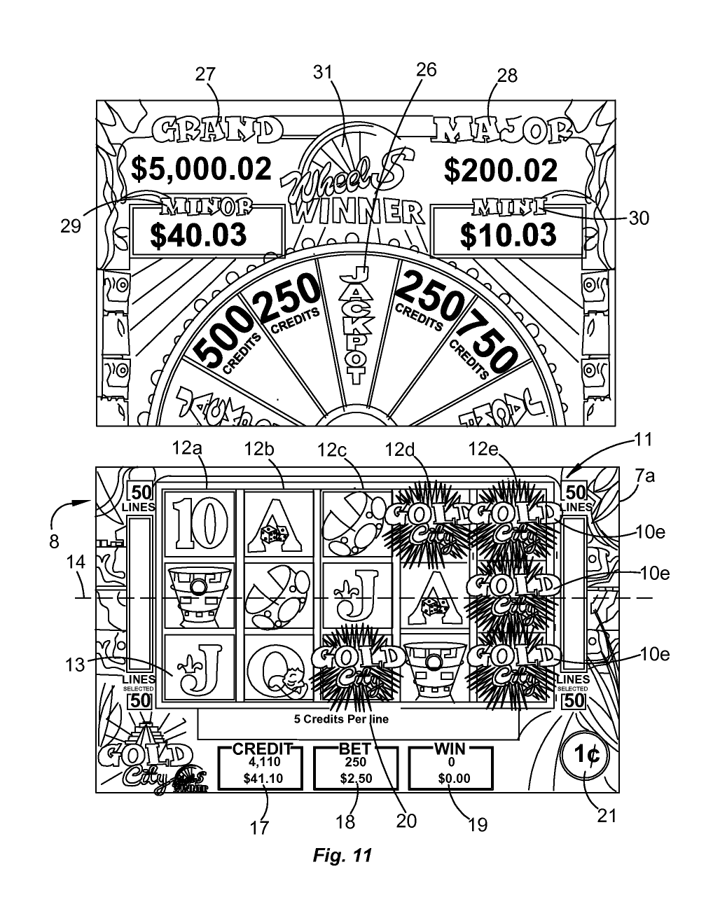

Similarly, a bet of five credits per pay line 14 results in selection of a “Bet 5” wheel 23d, as best shown in FIG. 10. The Bet 5 wheel 23d has five jackpot wedges 26, equal to the number of credits bet per pay line 14, thus providing an increase probability of winning a jackpot compared to the Bet 1, Bet 2 and Bet 3 wheels 23a, 23b, 23c. The other wedges 24 of the Bet 5 wheel 23d provide increased chances of winning the same prize from the previous wheels 23 (such as three wedges awarding 500 credits while only two wedges in the Bet 3 wheel 23c award 500 credits) or prizes of higher value (such as the wedges awarding 750 or 1250 credits). Since there are a reduced number of other wedges 24 due to the increased number of jackpot wedges 26, the Bet 5 wheel 23d does not provide awards of lower value that may be found the previous wheels, such as 75 or 200 credits, but this is offset by the increased probability of winning a jackpot or prizes of higher value. Some probabilities of winning the same prize are the same, such as the award of 250 credits being provided by two wedges in both the Bet 3 and Bet 5 wheels 23c, 23d. The Bet 5 wheel 23d also has green coloured wedges 24 to further distinguish itself from the purple Bet 1 wheel 23a, blue Bet 2 wheel 23b and the dark red Bet 3 wheel 23c. Again, the upper video screen 7b changes to continue play of the base game 8 with the selected Bet 5 wheel 23d, as best shown in FIG. 11.

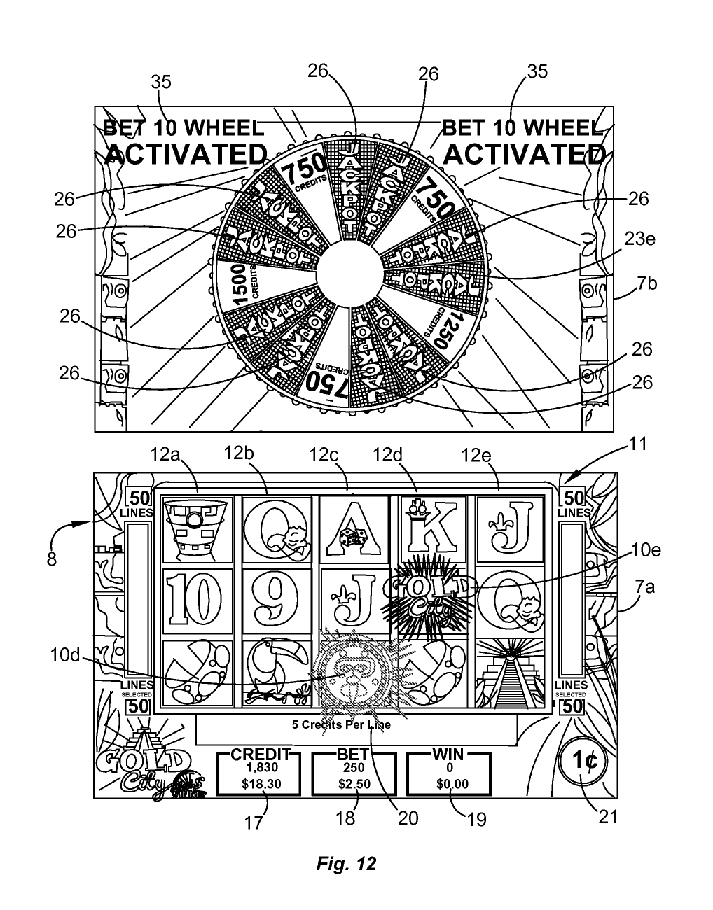

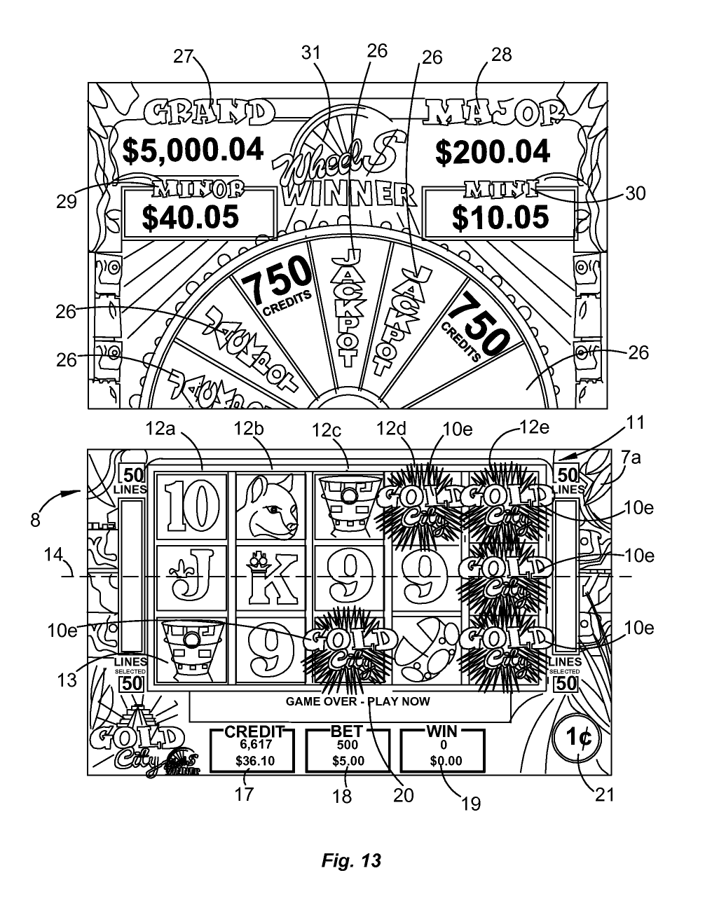

Finally, a bet of ten credits per pay line 14 results in selection of a “Bet 10” wheel 23e, as best shown in FIG. 12. The Bet 10 wheel 23e has ten jackpot wedges 26, equal to the number of credits bet per pay line 14, thus providing an increase probability of winning a jackpot compared to the Bet 1, Bet 2, Bet 3 and Bet 5 wheels 23a, 23b, 23c, 23d. The other wedges 24 of the Bet 10 wheel 23e provide increased chances of winning the same prize from the other wheels (such as three wedges awarding 750 credits compared to only one wedge in the Bet 5 wheel 23d or three wedges awarding 500 credits compared to two wedges in the Bet 3 wheel 23c) or prizes of higher value (such as the wedges awarding 1500 credits). Since there are a reduced number of other wedges 24 due to the increased number of jackpot wedges 26, the Bet 10 wheel 23e does not provide awards of lower value that may be found the previous wheels, such as 300 or 500 credits but this is offset by the increased probability of winning a jackpot or prizes of higher value. Some probabilities of winning the same prize are the same (such as a single wedge awarding 1250 credits, the same as in the Bet 5 wheel 23d). The Bet 10 wheel 23e also has light blue coloured wedges 24 to further distinguish itself from the purple Bet 1 wheel 23a, blue Bet 2 wheel 23b, the dark red Bet 3 wheel 23c and the green Bet 5 wheel 23d. Again, the upper video screen 7b changes to continue play of the base game 8 with the selected Bet 5 wheel 23d, as best shown in FIG. 13.

There is also a trigger event in the base game 8 for the feature game 9. In this embodiment, the trigger event is the appearance of three scatter symbols in the form of the gold mask symbols 10d on the array 11 in any of the cells 13, as best shown in FIG. 6. The feature game 9 is displayed in both video screens 7a and 7b, as best shown in FIG. 10, where corresponding features have been given the same reference numerals. In this embodiment, the feature game 9 uses the same game symbols 10 as the base game 8, as well as the same array 11, reels 12, cells 13 and player-selectable pay lines 14 on the video screen 7a. In the feature game 9, ten free plays or spins of the feature game are awarded to the player without having to make an additional bet or wager. The number of free games remaining in the feature game 9 is indicated by a counter 50. Typically, these free plays are commonly referred to as “free games”.

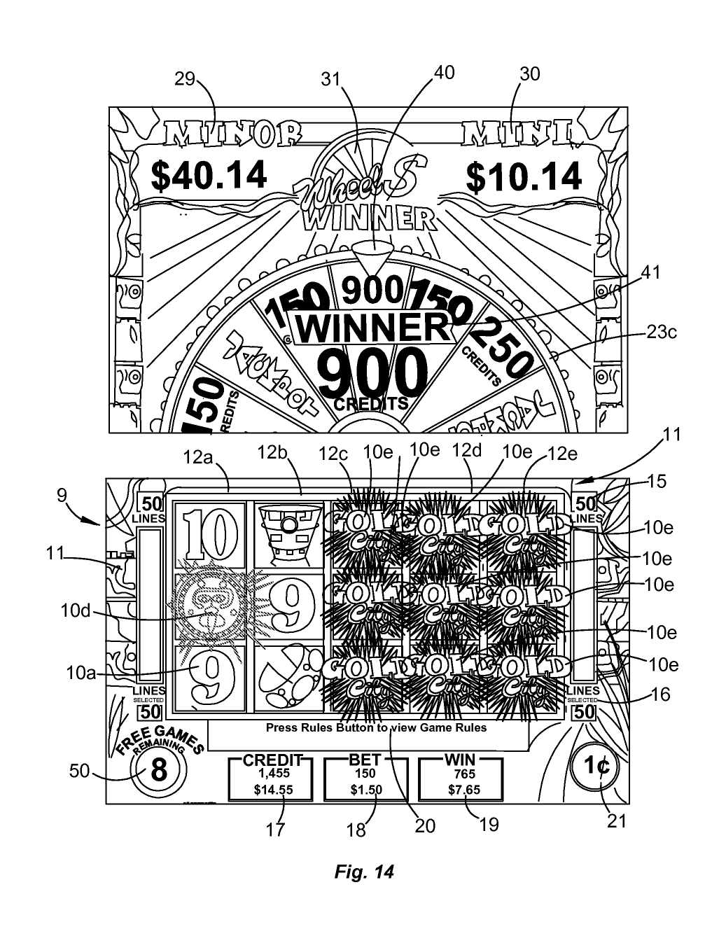

The feature game 9 operates in a similar manner to the base game 8, where the reels 12 visibly rotate and display randomly selected game symbols 10 in each cell 13, as best shown in FIG. 14. Also, the selected wheel 23 for the base game 8 is carried over into the feature game 9 and operates in the same way as described above with the exception that it is not possible to change the selected wheel during play of the feature game 9 since the feature game 9 is free and thus there is no provision for the player to change his or her bet (credits per pay line 14).

FIG. 10 also illustrates the trigger combination to activate the selected wheel, which in this case is the Bet 3 wheel 23c. The trigger combination of five playing card “9” symbols 10a has appeared in the array 11 of base game 8, comprising two “9” playing card symbols and three substitute Gold City symbols 10e. This has activated the selected Bet 3 wheel 23c, which has randomly selected the award of 900 credits. In the feature game 9, the Grand and Major progressive jackpot prizes 27, 28 are unavailable due to the last reel 12e being held wild (i.e. the last reel 12e only displays wild or substitute Gold City symbols 10e). This means that a “pure” combination of five game symbols 10a, 10b, 10c cannot be obtained. As such, both of these prizes are removed from the upper video screen 7b and only the minor jackpot 29 and the midi jackpot 30 are shown.

When a jackpot wedge 26 is randomly selected after a spin of a selected wheel 23, the player is awarded one of the jackpots depending on the composition of the trigger combination that activated the selected wheel 23 to spin. If the trigger combination was a “pure” combination of the same game symbols 10 without any substitute Gold City symbols 10e, then the player is eligible to receive either the grand jackpot 27 or the major jackpot 23. The grand jackpot 27 is awarded if the pure combination comprises the same picture game symbol or item symbol 10b, 10c and the major jackpot is awarded if the pure combination comprises the same playing card game symbol 10a. If the trigger combination was a combination of game symbols 10 and substitute Gold City symbols 10e, then the player is eligible to receive either the minor jackpot 29 or the midi jackpot 30. The minor jackpot 29 is awarded if the trigger combination comprises the same picture game symbol or item symbol 10b, 10c with one or more Gold City symbols 10e and the midi jackpot is awarded if the trigger combination comprises the same playing card game symbol 10a with one or more Gold City symbols 10e. It will be appreciated that the jackpots can be awarded on other criteria other than described. For example, the midi jackpot could be awarded where the trigger combination comprises only of substitute Gold City symbols 10e.

While the embodiments of the invention have been described as using mostly fixed monetary prizes for the selected wheels 23, it will be appreciated that other game enhancing elements can be awarded instead or in conjunction with monetary prizes. For example, the wedges 24 in the selected wheels can have game enhancing symbols such as “Held Reels”, “×10 Multiplier” (applicable to the prize awarded by the base game for the five of a kind trigger combination and/or to the total amount of the bet or credits bet per pay line), “10 Free Spins/Games”, progressive symbols and changing the function of a standard game symbol 10a, 10b into a substitute symbol in addition to any displayed Gold City substitute symbols 10e. Held columns or reels typically involve the column or reel to only display wild/substitute symbols, thus enhancing the probability of achieving a predetermined combination. Progressive symbols award a prize is awarded upon a certain number of progressive symbols are accumulated by the player over a number of games played on the gaming machine. Other examples include:
i) 15 Free Games;
ii) 10 Free Games;
iii) 8 Free Games;
iv) Bonus Prize of 5× bet (the total amount of the bet or credits bet per pay line);
v) Bonus Prize of 10× bet (the total amount of the bet or credits bet per pay line);
vi) Bonus Prize of 25× bet (the total amount of the bet or credits bet per pay line);
vii) All royal card symbols change to wilds (substitute symbols) on reels 2, 3 and 4 of each selected first array;
viii) All picture symbols change to wilds on reels 2, 3 and 4 of each selected first array;
ix) All symbols on reels 2 and 4 of each selected first array change to wild symbols; and
x) All symbols on reels 1 and 5 4 of each selected first array change to wild symbols.

These game enhancing symbols do not modify the function or value of the game symbols 10 that appear on the first arrays, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can takes effect with the next play of the game instead of applying to the result of the spun array 11. In another preferred form, the game enhancing symbols may indicate the duration in which its game enhancing element is applied, such as a predetermined number of spins or a predetermined time period.

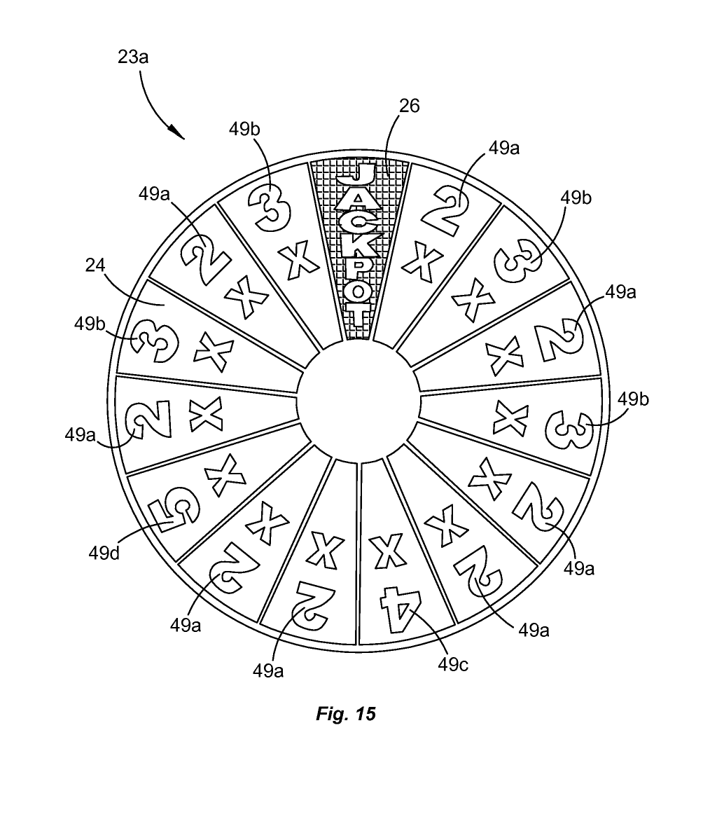

A second embodiment of the invention is illustrated in FIGS. 15 to 20, where corresponding features have been given the same reference numerals. These figures show the wheels 23a to 23f as they would be displayed on the upper video screen 7 when the wheel is selected, such as in FIG. 4, or during game play. In this embodiment, the bonus prizes in each of the wheels 23a to 23e have been replaced by win multipliers in the form of multiplier symbols 49 having multiplier values of ×2, ×3, ×4, ×5, ×6, ×7, ×8, ×9, ×10, ×12, ×15, ×16, ×20, ×25, ×30, ×35, ×40 and ×60. Also, there are six wheels instead of five, so a new Bet 4 wheel 23f is provided that is selected upon a bet of 4 credits per pay line 14 and has orange coloured wedges.

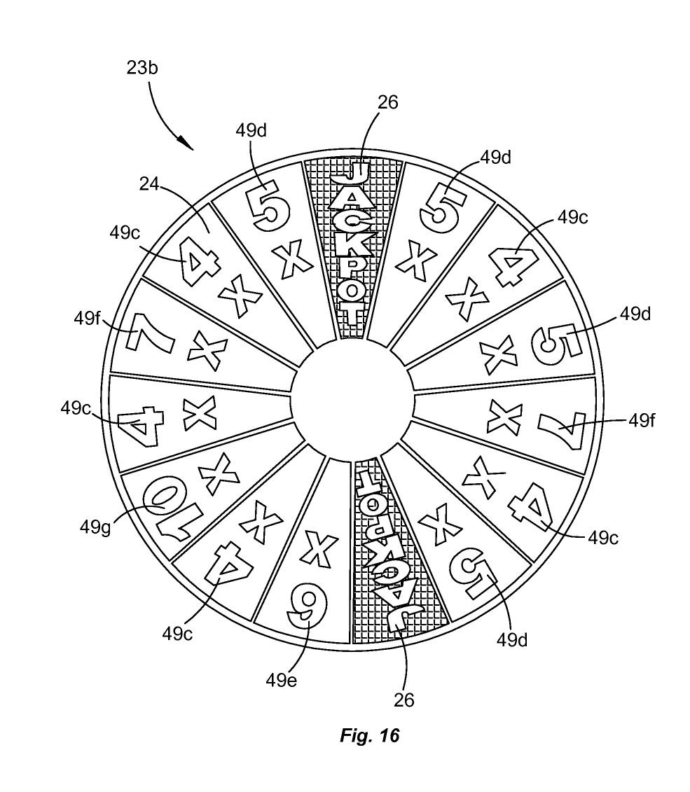

Referring to FIG. 15, the Bet 1 wheel 23a has wedges 24 that confer win multiplier symbols 49a, 49b, 49c and 49d that award win multiplier values of ×2, ×3, ×4 and ×5, respectively. Referring to FIG. 16, the Bet 2 wheel 23b has the same number of wedges 24 as the Bet 1 wheel 23a, but either provides win multiplier values of increased value that were not available in the Bet 1 wheel (such as the multiplier symbols 49e, 49f and 49g that award win multiplier values of ×6, ×7 and ×10, respectively) or an increased probability of winning the same win multiplier value offered on the Bet 1 wheel (such as four wedges 24 having the ×5 win multiplier symbol 49d in the Bet 2 wheel, whereas there is only one wedge 24 having the ×5 win multiplier symbol 49d in the Bet 1 wheel). Also, as in the first embodiment, the number of jackpot wedges 26 has increased so as to be equal to the number of credits bet per line, from one wedge in the Bet 1 wheel to two wedges in the Bet 2 wheel.

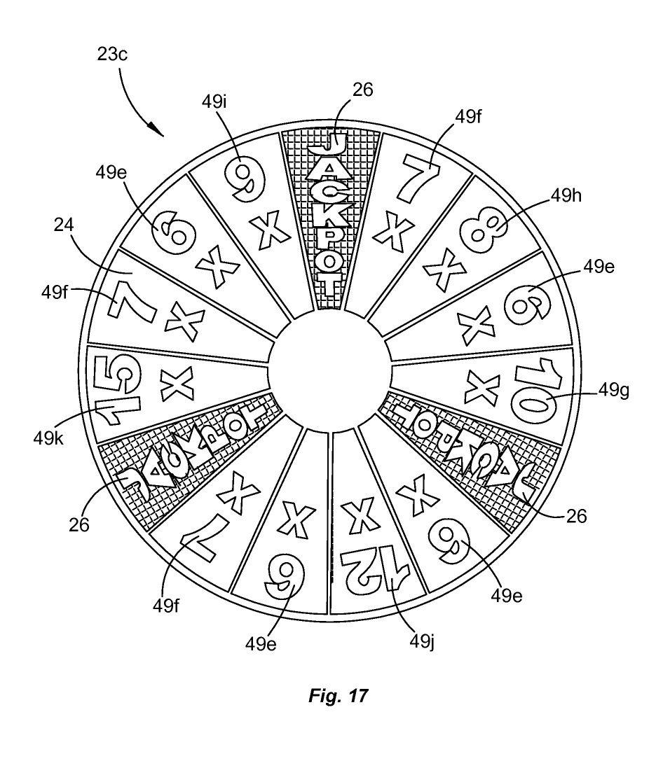

Similar changes to the other bet wheels 23c to 23f also take place. Referring to FIG. 17, the Bet 3 wheel 23c has three jackpot wedges 26, equal to the number of credits bet per pay line 14, thus providing an increase probability of winning a jackpot compared to the Bet 1 and Bet 2 wheels 23a, 23b. The other wedges 24 of the Bet 3 wheel 23c also provide increased chances of winning the same win multiplier value from the Bet 2 wheel 23b (such as the multiplier symbols 49e, 49f and 49g that award win multiplier values of ×6, ×7 and ×10, respectively) or a win multiplier of different or higher values (such as the multiplier symbols 49h, 49i, 49j and 49k that award win multiplier values of ×8, ×9, ×12 and ×15, respectively).

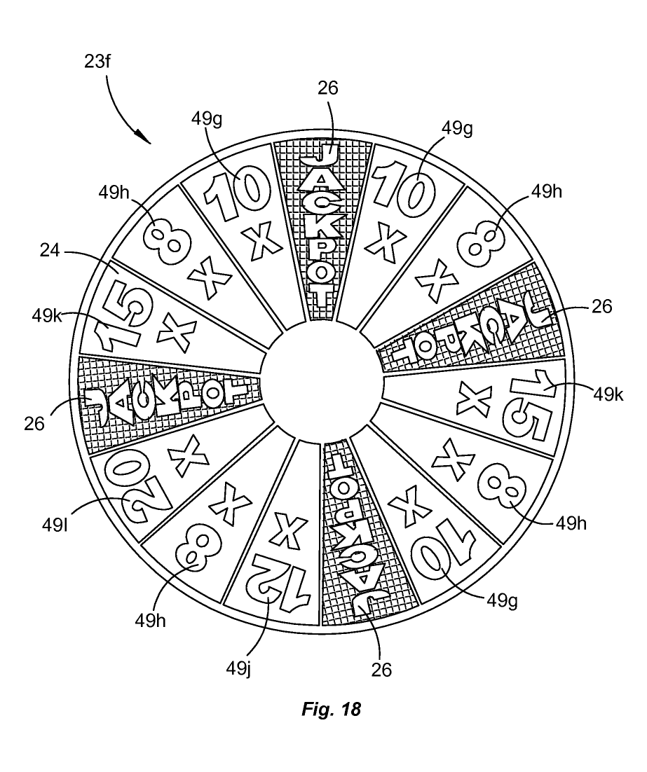

Referring to FIG. 18, the Bet 4 wheel 23f has four jackpot wedges 26, equal to the number of credits bet per pay line 14, thus providing an increase probability of winning a jackpot compared to the Bet 1, Bet 2 and Bet 3 wheels 23a, 23b, 23c. The other wedges 24 of the Bet 4 wheel 23f provide increased chances of winning the same win multiplier value from the Bet 3 wheel 23c (such as the multiplier symbols 49h, 49j and 49k that award win multiplier values of ×8, ×12 and ×15, respectively) and/or Bet 2 wheel 23b (being the ×10 win multiplier symbol 49g). Also the Bet 4 wheel 23f can award win multipliers of higher value (such as the ×20 win multiplier symbol 49l). Since there are a reduced number of other wedges 24 due to the increased number of jackpot wedges 26, the Bet 4 wheel 23f does not provide win multipliers of lower value that may be found the previous wheels, such as ×2 and ×5 win multipliers, but this is offset by the increased probability of winning a jackpot or win multipliers of higher value. Some probabilities of winning the same win multiplier are the same, such as the ×12 win multiplier symbol 49j being provided by one wedge in both the Bet 3 and Bet 4 wheels 23c and 23f.

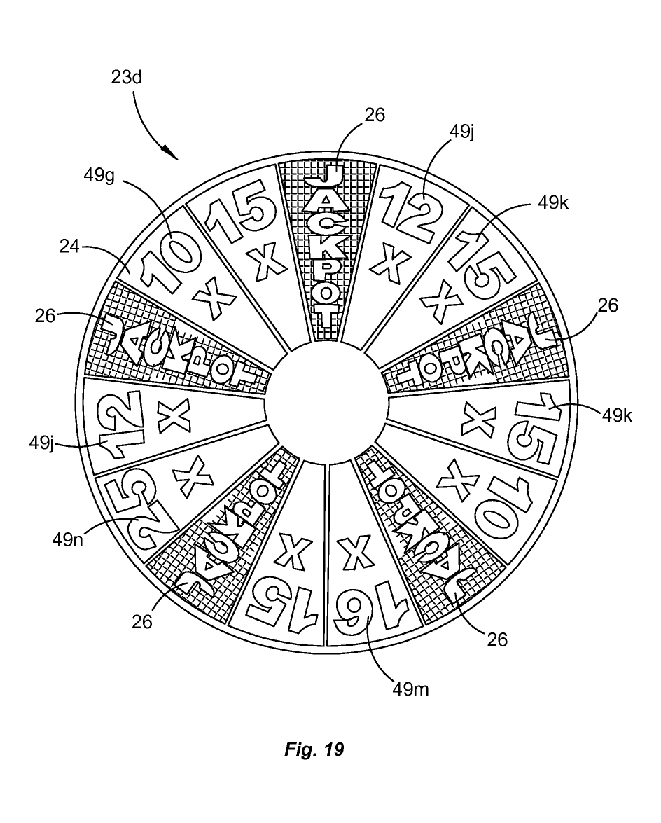

Referring to FIG. 19, the Bet 5 wheel 23d has five jackpot wedges 26 and wedges 24 that provide increased chances of winning the same win multiplier value from the Bet 4 wheel 23f (such as the multiplier symbols 49j and 49k that award win multiplier values of ×12 and ×15, respectively) and/or Bet 1 and Bet 2 wheels 23a and 23b (being the ×10 win multiplier symbol 49g). Also, the Bet 5 wheel 23d can award win multipliers of different or higher values (such as the ×16 and ×25 win multiplier symbols 49m and 49n, respectively). Again, the reduced number of wedges 24 due to the increased number of jackpot wedges 26 means that win multipliers of lower value are not present, such as the ×8 and ×9 win multipliers, but this is offset by the increased probability of winning a jackpot or win multipliers of higher value.

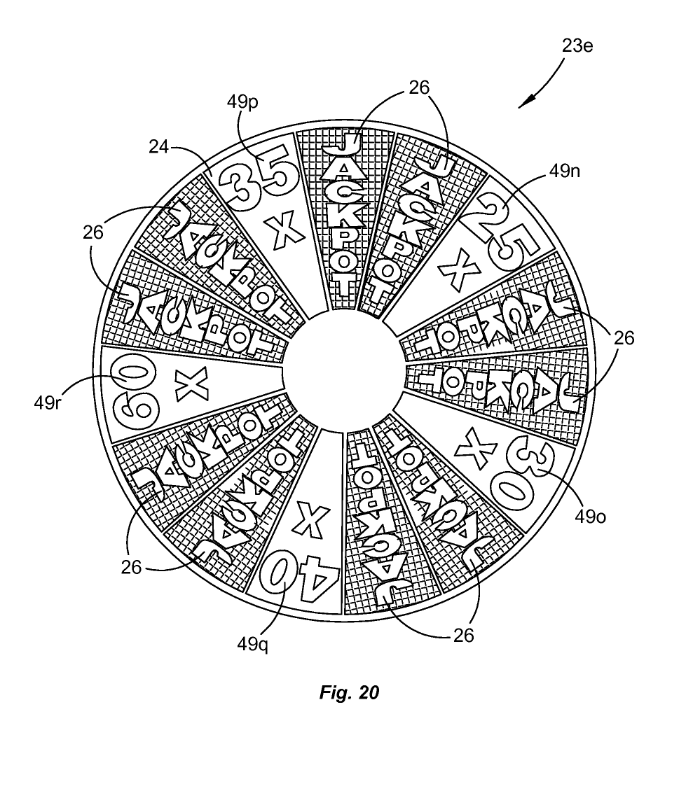

Finally, with reference to FIG. 20, the Bet 10 wheel 23e has ten jackpot wedges 26 and other wedges 24 that provide win multipliers of higher value (such as the ×30, ×35, ×40 and ×60 win multiplier symbols 49o, 49p, 49q and 49r, respectively). Again, the reduced number of other wedges 24 due to the increased number of jackpot wedges 26 means that the Bet 10 wheel 23e does not provide awards of lower value that may be found the previous wheels, such as the ×15 and ×20 win multipliers, but this is offset by the increased probability of winning a jackpot or prizes of higher value. Some probabilities of winning the same prize are the same (such as a single wedge awarding the ×25 win multiplier symbol 49n, the same as in the Bet 5 wheel 23d).

In all other respects, the second embodiment operates in substantially the same way as described above in relation to the first embodiment. Hence, a further detailed description of the operation of the second embodiment will not be provided to avoid repetition.

In other preferred forms, an enhanced version of the selected wheel 23 appears in the feature game 9 or as a result of a game enhancing element being awarded by the selected wheel. The enhanced wheel provides additional game enhancing symbols that include the award of points or an additional 5 free spins of the array 11 (i.e., retriggering 5 more free spins). The collection of points awarded by the enhanced wheel 22 during free spins or game leads to the trigger of additional prizes or game enhancing symbols, depending on the number of points that are collected. These additional prizes can include stand alone progressive jackpots, bonus prizes and super games, which are enhanced versions of free spins or games where there are greater pay outs or frequency of wins. In addition, the enhanced wheel is accompanied by animations and sounds to indicate to the player that the enhanced wheel is active. The enhanced wheel also has a different visual representation to the selected wheel 23.

The grand progressive jackpot is confined to the electronic gaming machine 1. However, in another preferred form, the grand progressive jackpot is configured to be part of a wide area or in-house link progressive jackpot. In other words, the grand progressive jackpot can be awarded on a group of networked gaming machines in a specified area or a group of specified electronic gaming machines that are linked together for jackpot purposes.

Although the preferred embodiments of the invention have been described as awarding a single prize or game enhancing element in the selected wheel 23, it will be appreciated that the wheels can be configured to award any number or types of game enhancing elements. Also, where the selected wheel awards more than one game enhancing element, the game enhancing elements are individually selected one at a time. In other words, the game enhancing elements are selected sequentially. In addition, the enhanced wheels may provide game enhancing symbols of greater value and/or frequency compared to the selected wheel 23.

Furthermore, the embodiments of the invention have been described as providing each of the wheels 23 with the same number of wedges and each wheel 23 offering a mixture of common and different prizes or game enhancing elements. However, it will be appreciated that in other embodiments, the number of wedges in the wheels may vary to alter the respective probabilities offered in each wheel, and that some wheels can have exclusive prizes or comprise only of unique prizes or game enhancing elements not awarded by other wheels. This may be done where the player wages a maximum amount or selects the maximum bet option, enabling access to a wheel with exclusive prizes and/or game enhancing elements not available in the other wheels.

While the preferred embodiment of the invention has been described in relation to a base game 8 and a feature game 9, those skilled in the art will appreciate that the use of a plurality of bet-based interchangeable wheels can readily be applied to the base game alone or a feature game alone.

In another embodiment, the amount of the bet that determines which wheel is selected is the total amount that is bet on the game and not the credits bet per pay line. That is, the total number of credits (or monetary amount) that is bet by the player for a play of the game. In other preferred forms, the amount of that is bet per pattern or “way” determines which wheel is selected by the electronic game controller. For example, for an industry standard set of five reels with three rows, there are 243 unique combinations of cells 13 or “ways”. Thus, the electronic game controller can provide bet options based on the number of ways and hence associate and select wheels based on the amount bet per way.

In a further embodiment, the number of jackpot wedges is proportional to the number of credits up to a predetermined limit. For example, two jackpot wedges are provided for each credit that is bet, so that a bet of three credits per pay line results in the selected wheel having six jackpot wedges. Conversely, the number of jackpot wedges is proportional to the number of credits down to a predetermined limit. For example, a jackpot wedge is provided for every three credits bet, irrespective of the number of credits bet per pay line. This would result in a bet of nine credits (which could be spread over nine pay lines) resulting in the selected wheel having three jackpot wedges.

Also, in a further preferred form, the player can selectively stop spinning of the selected wheel to increase player interaction and provide the player with an opportunity to guess when a wedge 24 containing a desired prize or game enhancing may appear at the pointer 40. Furthermore, the player can start spinning of the selected wheel 23 to further enhance player interaction.

In other preferred forms, the array 11 and selected wheel 23 need not be displayed on separate screens 7a, 7b. Instead, they may be displayed on a single screen.

In another preferred form, the video screens 7a, 7b are touch screens for use in addition to the player-actuatable buttons 5 so as to enable the player to select various features, such as making monetary bets for the base game, initiating play of the base and feature games played on the array 11 and responding to any messages or requests issued on the electronic gaming machine 1 by the electronic game controller. In this case, the player may control when the selected wheel 23 starts spinning and stops spinning by simply touching the selected wheel 23.

In other preferred forms, the jackpot prize can be shared with any other games offered on the electronic gaming machine (as in multi-game gaming machines) or games offered on separate electronic gaming machines. In one preferred form, the jackpot prize comprises a mystery jackpot. That is, none of the symbols in the game trigger the jackpot; hence the triggering event is a “mystery”. By way of comparison, a standard jackpot is typically symbol driven in that a particular combination of symbols must occur in the game to trigger the standard jackpot.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer programme configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of the player being able to selectively starting or stopping spinning of the selected wheel 23 and the feature of providing an enhanced wheel in the feature game can be combined into a single electronic gaming machine. Similar combinations of two or more features from the above described embodiments or preferred forms of the invention can be readily made by one skilled in the art.

By providing a wheel-type game in conjunction with another game, where the wheels for the wheel-type game can be changed based on the bet made by the player, the player's interest in the electronic gaming machine is increased as there is more chance of winning additional prizes of increasing value depending on the amount of the bet. Thus, the invention retains the player interest and so the player is likely to continue playing the same electronic gaming machine. The player's anticipation and excitement is also heightened as he or she knows that an additional prize will be won on the selected wheel once the trigger combination is achieved in the (base or feature) game. The invention also adds greater value to a player in terms of the probability of winning a prize relative to the amount bet or wagered, especially compared to a conventional electronic gaming machine that only has one set of reels and a single feature game. This value to the player is increased in the preferred embodiments of the invention by extending play of the selected wheel to the feature game in addition to the base game.

All these advantages of the invention result in the player being more likely to retain interest in continuing to play the same electronic gaming machine due to the variation in game play on the electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a display for displaying a game and a wheel-type game, wherein predetermined winning combinations of randomly selected game symbols in said game award prizes to a player and randomly selected wheel elements in said wheel-type game award prizes and/or confer game enhancing elements to said player, said wheel-type game comprising a plurality of wheels, said wheels having different wheel elements to vary the probability of winning a prize or game enhancing element in said wheel-type game, and
an electronic game controller for controlling the display of said game symbols and said wheel elements in said game and said wheel-type game, respectively, on said display,
wherein said electronic game controller configures said electronic gaming machine to provide a plurality of selectable bet options to play said game and said electronic game controller associates each of said bet options with one of said wheels such that selection of a first bet option to play said game causes said electronic game controller to select the wheel associated with said first bet option.

2. The electronic gaming machine of claim 1, wherein the probability of winning a prize or game enhancing element in said selected wheel is proportional to the amount of said first bet option.

3. The electronic gaming machine of claim 1, wherein at least one of said prizes in each wheel comprises a jackpot prize and each said wheel comprises one or more jackpot wheel elements which awards said jackpot prize to said player.

4. The electronic gaming machine of claim 3, wherein said game comprises an array of predetermined game positions which are occupied by said randomly selected game symbols and said predetermined winning combinations are defined by a plurality of selectable combinations of said game positions, said first bet option comprises a number C of credits bet per selectable combination and said wheel associated with said first bet option comprises a number J of said jackpot wheel elements, and wherein the other of said bet options each comprise n×C credits bet per selectable combination where n×C is proportional to C, and the wheels respectively associated with each of said other bet options comprise n×J jackpot wheel elements.

5. The electronic gaming machine of claim 3, wherein said first bet option comprises a total number of C credits bet in a play of said game and said wheel associated with said first bet option comprises a number J of said jackpot wheel elements, and wherein the other of said bet options each comprise n×C credits bet in said play of said game where n×C is proportional to C and the wheels respectively associated with each of said other bet options comprise n×J jackpot wheel elements.

6. The electronic gaming machine of claim 3, wherein said game comprises an array of predetermined game positions which are occupied by said randomly selected game symbols, said predetermined winning combinations are defined by a plurality of combinations of said game positions and said game position combinations are formed into two or more selectable groups of combinations, said first bet option comprises a number C of credits bet per selectable group and said wheel associated with said first bet option comprises a number J of said jackpot wheel elements, and wherein the other said bet options each comprise n×C credits bet per selectable group where n is proportional to C, and the wheels respectively associated with each of said other bet options comprise n×J jackpot wheel elements.

7. The electronic gaming machine of claim 1, wherein said electronic game controller changes said selected wheel in response to a change from said first bet option to a second bet option different to said first bet option, said electronic game controller selecting the wheel associated with said second bet option.

8. The electronic gaming machine of claim 7, wherein said electronic game controller causes the wheel associated with said second bet option to be at least partly displayed on said display to indicate the change in said selected wheel to said player.

9. The electronic gaming machine of claim 1, wherein at least one of said wheels comprises a wheel element that confers a first bonus prize, said first bonus prize comprising a fixed amount multiplied by the amount of said first bet option or said second bet option.

10. The electronic gaming machine of claim 1, wherein at least one of said wheels comprises a wheel element that confers a second bonus prize comprising a randomly chosen value.

11. The electronic gaming machine of claim 1, wherein at least one of said wheels comprises a wheel element that confers a win multiplier.

12. The electronic gaming machine of claim 1, wherein the number of said wheel elements in each of said wheels is the same, and at least one of said wheel elements in at least two of said wheels awards the same prize or game enhancing element.

13. The electronic gaming machine of claim 1, wherein the number of said wheel elements in each of said wheels is the same, and at least one wheel element in one of said wheels awards a different prize or game enhancing element to the prize or game enhancing element awarded by at least one wheel element in another of said wheels.

14. The electronic gaming machine of claim 1, wherein a trigger combination of game symbols appearing in said game triggers said selected wheel to randomly select one of its wheel elements.

15. The electronic gaming machine of claim 14, wherein said trigger combination comprises five of the same game symbols appearing in said game.

16. The electronic gaming machine of claim 1, wherein said game comprises a base game and/or a feature game.

17. A gaming method for an electronic gaming machine comprising a display and an electronic game controller, comprising:
controllably displaying a game and a wheel-type game, wherein predetermined winning combinations of randomly selected game symbols in said game award prizes to a player and randomly selected wheel elements in said wheel-type game award prizes and/or confer game enhancing elements to said player;
providing a plurality of wheels for said wheel-type game, said wheels having different wheel elements to vary the probability of winning a prize or game enhancing element in said wheel-type game;
providing a plurality of bet options to play said game;
associating each of said bet options with one of said wheels;
receiving a selection of a first bet option to play said game, and
selecting the wheel associated with said first bet option for play with said game.

18. The gaming method of claim 17, wherein said associating step further comprises associating a wheel with said first bet option so that the probability of winning a prize or game enhancing element in said selected wheel is proportional to the amount of said first bet option.

19. The gaming method of claim 17, further comprising providing a jackpot prize as at least one of said prizes awarded by each wheel and providing each said wheel with one or more jackpot wheel elements which awards said jackpot prize to said player.

20. The gaming method of claim 19, wherein said game comprises an array of predetermined game positions which are occupied by said randomly selected game symbols and said predetermined winning combinations are defined by a plurality of selectable combinations of said game positions, said first bet option comprises a number C of credits bet per selectable combination and said wheel associated with said first bet option comprises a number J of said jackpot wheel elements, and wherein the other of said bet options each comprise n×C credits bet per selectable combination where n×C is proportional to C, and the wheels respectively associated with each of said other bet options comprise n×J jackpot wheel elements.

21. The gaming method of claim 19, wherein said first bet option comprises a total number of C credits bet in a play of said game and said wheel associated with said first bet option comprises a number J of said jackpot wheel elements, and wherein the other of said bet options each comprise n×C credits bet in said play of said game where n×C is proportional to C and the wheels respectively associated with each of said other bet options comprise n×J jackpot wheel elements.

22. The gaming method of claim 19, wherein said game comprises an array of predetermined game positions which are occupied by said randomly selected game symbols, said predetermined winning combinations are defined by a plurality of combinations of said game positions and said game position combinations are formed into two or more selectable groups of combinations, said first bet option comprises a number C of credits bet per selectable group and said wheel associated with said first bet option comprises a number J of said jackpot wheel elements, and wherein the other said bet options each comprise n×C credits bet per selectable group where n is proportional to C, and the wheels respectively associated with each of said other bet options comprise n×J jackpot wheel elements.

23. The gaming method of claim 17, further comprising receiving a second bet option different to said first bet option and changing said selected wheel to the wheel associated with said second bet option.

24. The gaming method of claim 23, further comprising indicating said change in said selected wheel to said player.

25. The gaming method of claim 24, further comprising displaying at least part of said wheel associated with said second bet option to indicate said change.

26. The gaming method of claim 17, further comprising providing at least one of said wheels with a wheel element that confers a first bonus prize, said first bonus prize comprising a fixed amount multiplied by the amount of said first bet option or said second bet option.

27. The gaming method of claim 17, further comprising providing at least one of said wheels with a wheel element that confers a second bonus prize comprising a randomly chosen value.

28. The gaming method of claim 17, further comprising providing at least one of said wheels with a wheel element that confers a win multiplier.

29. The gaming method of claim 17, further comprising providing the same number of said wheel elements in each of said wheels, and providing at least one of said wheel elements in at least two of said wheels to award the same prize or game enhancing element.

30. The gaming method of claim 17, further comprising providing the same number of said wheel elements in each of said wheels is the same, and providing at least one wheel element to award a different prize or game enhancing element to the prize or game enhancing element awarded by at least one wheel element in another of said wheels.

31. The gaming method of claim 17, further comprising triggering said selected wheel to randomly select one of its wheel elements, said triggering being in response to a trigger combination of game symbols appearing in said game.

32. The gaming method of claim 31, wherein said trigger combination comprises five of the same game symbols appearing in said game.

33. A computer system comprising a central processing unit configured for communication with an electronic gaming machine, wherein said computer system is configured to perform the method of claim 17.

34. A computer program configured to perform the method of claim 17.

35. A non-transitory carrier medium carrying computer executable code that, when executed on a central processing unit configured for communication with an electronic gaming machine, causes said central processing unit to perform the method of claim 17.
